(19) United States
(12) Patent Application Publication
(10) Pub. No.: US 2011/0318551 A1
(43) Pub. Date: Dec. 29, 2011

(54) INKJET RECORDING INK, PROCESS FOR PRODUCING THE INKJET RECORDING INK, INKJET CARTRIDGE, INKJET RECORDING APPARATUS, AND INKJET RECORDED IMAGE

(76) Inventor: Tomohiro NAKAGAWA, Kanagawa (JP)

(21) Appl. No.: 13/112,879

(22) Filed: May 20, 2011

(30) Foreign Application Priority Data
Jun. 25, 2010 (JP) 2010-145068

(51) Int. Cl. B32B 3/10; C09D 11/10; B41J 2/175; B82Y 30/00

(52) U.S. Cl. 428/206; 347/86; 524/507; 523/201; 977/773

(57) ABSTRACT

Provided is an inkjet recording ink including: a resin nanoparticle having a core-shell structure containing a core and a shell; a pigment; a water-soluble organic solvent; and water, wherein the core is composed of a poly(meth)acrylate resin, and wherein the shell is composed of a polycarbonate-polyurethane copolymer. Also provided is a process for producing the inkjet recording ink, an inkjet cartridge containing the inkjet recording ink, an inkjet recording apparatus containing the inkjet cartridge, and an inkjet recorded image including the inkjet recording ink located on a recording medium.

### CROSS-REFERENCE TO RELATED APPLICATIONS

The present application claims priority to Japanese patent application JP 2010-145068, filed on Jun. 25, 2010, which is hereby incorporated by reference in its entirety.

### BACKGROUND OF THE INVENTION

1. Field of the Invention

The present invention relates to an inkjet recording ink, a process for producing the inkjet recording ink, an inkjet cartridge comprising the inkjet recording ink, an inkjet recording apparatus comprising the inkjet cartridge, and an inkjet recorded image comprising the inkjet recording ink located on a recording medium.

2. Discussion of the Background

Conventional inkjet recording inks suffer from various drawbacks including, but not limited to, inferior ink storage stability, inferior discharge stability and undesirable adhesion to an inkjet nozzle of an inkjet recording apparatus, inferior resistance to abrasion and inferior resistance to smudging.

Yasui (JP 2004-131586) describes an aqueous pigment recording liquid containing an aqueous pigment dispersion comprising a poly(meth)acrylate resin, a polyurethane resin, a pigment and water. The poly(meth)acrylate resin and the polyurethane resin of Yasui exist as separate and distinct resins which are not bound together by a chemical bond or adhered to one another by physical adhesion. Sakurai (JP 09-263720) describes an ink composition comprising a polyethylene oxide-based amphipathic compound, a pigment in the form of an ultrafine particulate and a water-based solvent. The aqueous pigment recording liquid of Yasui and the ink composition of Sakurai suffer from inferior ink storage stability, inferior discharge stability and undesirable adhesion to an inkjet nozzle of an inkjet recording apparatus, inferior resistance to abrasion and/or inferior resistance to smudging.

Accordingly, there remains a critical need for an inkjet recording ink that exhibits improved ink storage stability, improved discharge stability and a reduction and/or elimination of undesirable adhesion to an inkjet nozzle of an inkjet recording apparatus, improved resistance to abrasion and improved resistance smudging, relative to those properties exhibited by conventional inkjet recording inks.

### SUMMARY OF THE INVENTION

The present invention relates to an inkjet recording ink, a process for producing the inkjet recording ink, an inkjet cartridge comprising the inkjet recording ink, an inkjet recording apparatus comprising the inkjet cartridge, and an inkjet recorded image comprising the inkjet recording ink on a recording medium.

An exemplary aspect of the present invention is to provide an inkjet recording ink comprising: a resin nanoparticle having a core-shell structure comprising a core and a shell; a pigment; a water-soluble organic solvent; and water, where the core comprises a poly(meth)acrylate resin, and where the shell comprises a polycarbonate-polyurethane copolymer.

The resin nanoparticle may have a volume average particle diameter of 10-350 nm. The core may have a volume average particle diameter of 5-200 nm. The shell may have a volume average particle diameter of 5-150 nm. The resin nanoparticle may have a core to shell weight ratio of 8/2 to 2/8. The resin nanoparticle has a shape factor SF-A value of 0.88-0.90.

An exemplary aspect of the present invention is to provide an inkjet recording ink that exhibits improved ink storage stability, improved discharge stability and a reduction and/or elimination of undesirable adhesion to an inkjet nozzle of an inkjet recording apparatus, improved resistance to abrasion and improved resistance to smudging, relative to those properties exhibited by conventional inkjet recording inks.

An exemplary aspect of the present invention is to provide an ink composition comprising: 0.5-5.0 wt. % of the resin nanoparticle, based on a total weight of the ink composition; 0.1-50.0 wt. % of the pigment, based on a total weight of the ink composition; 10.0-50.0 wt. % of the water-soluble organic solvent, based on a total weight of the ink composition; and a balance being water, where the total weight of the resin nanoparticle, the pigment, the water-soluble organic solvent, and water is 100 wt. %.

An exemplary aspect of the present invention is to provide a process for producing the inkjet composition, where the process comprises dispersing the resin nanoparticle and the pigment in water and the water-soluble organic solvent.

An exemplary aspect of the present invention is to provide a process for producing the inkjet composition, where the process comprises mixing, in the presence of a water-soluble organic solvent, a resin emulsion and a pigment dispersion, where the resin emulsion comprises the resin nanoparticle, and where the pigment dispersion comprises a pigment and water.

An exemplary aspect of the present invention is to provide a pigment dispersion that is a self dispersing pigment dispersion. An exemplary aspect of the present invention is to provide a pigment dispersion that is a surfactant dispersing pigment dispersion.

An exemplary aspect of the present invention is to provide a process for producing the resin emulsion, where the process comprises: reacting in a reaction mixture at least one polyol compound and at least one carbonate compound in the presence of a catalyst to produce a polycarbonate which is then reacted with at least one polyisocyanate compound to produce a polycarbonate-polyurethane copolymer; charging a (meth)acrylic acid monomer to the reaction mixture comprising the polycarbonate-polyurethane copolymer to produce a pre-polymer/monomer mixture; dispersing the pre-polymer/monomer mixture in an aqueous solution comprising a radical initiator and water to produce an aqueous dispersion; and heating the aqueous dispersion to thereby produce the resin emulsion comprising the resin nanoparticle having the core-shell structure comprising the core and the shell, where the core comprises the poly(meth)acrylate resin, and where the shell comprises the polycarbonate-polyurethane copolymer.

An exemplary aspect of the present invention is to provide a process for producing the resin emulsion, where the process comprises: reacting in a reaction mixture at least one polyol compound, at least one carbonate compound and at least one polyisocyanate compound in the presence of a catalyst to produce a polycarbonate-polyurethane copolymer; charging a (meth)acrylic acid monomer to the reaction mixture comprising the polycarbonate-polyurethane copolymer to produce a pre-polymer/monomer mixture; dispersing the pre-polymer/monomer mixture in an aqueous solution comprising a radical initiator and water to produce an aqueous dispersion; and heating the aqueous dispersion to thereby produce the resin emulsion comprising the resin nanoparticle having the core-shell structure comprising the core and the shell, where the core comprises the poly(meth)acrylate resin, and where the shell comprises the polycarbonate-polyurethane copolymer.

The (meth)acrylic acid monomer may be selected from one or more C₁-C₆ acrylic acid monomers, one or more C₁-C₆ methacrylic acid monomers, and combinations thereof.

The polyol compound may be selected from 1,3-propanediol, 2-methyl-1,3-propanediol, 1,4-butanediol, 1,6-propanediol, diethylene glycol, and combinations thereof.

The carbonate compound may be selected from ethylene carbonate, diphenyl carbonate, carbon oxychloride, and combinations thereof.

The polyisocyanate compound may be selected from ethylene diisocyanate, 1,6-hexamethylene diisocyanate, isophorone diisocyanate, 1,4-cyclohexane-diisocyanate, 4,4′-dicyclohexyl methane diisocyanate, 1,4-phenylene diisocyanate, 2,4-toluene diisocyanate, 2,6-toluene diisocyanate, 4,4′-diphenyl methane diisocyanate, 2,4′-diphenyl methane diisocyanate, poly methylene polyphenyl polyisocyanate, 1,5-naphthylenediisocyanate, and combinations thereof.

An exemplary aspect of the present invention is to provide an inkjet recording ink, which is the ink composition described above. An exemplary aspect of the present invention is to provide an inkjet cartridge comprising the inkjet recording ink. An exemplary aspect of the present invention is to provide an inkjet recording apparatus comprising the inkjet cartridge. An exemplary aspect of the present invention is to provide an inkjet recorded image comprising the inkjet recording ink located on a recording medium.

The foregoing discussion exemplifies certain aspects of the present invention. Additional exemplary aspects of the present invention are discussed in the following detailed description of the invention. The following description is to be regarded as illustrative in nature, and not as restrictive.

### BRIEF DESCRIPTION OF THE FIGURES

FIG. 1 illustrates a schematic diagram of an exemplary resin nanoparticle having a core-shell structure according to the present invention, and a volume average particle diameter thereof.

FIG. 2 illustrates a schematic diagram of an exemplary resin nanoparticle having a core-shell structure according to the present invention, and a shape thereof.

FIG. 3 illustrates a schematic diagram of an exemplary resin nanoparticle having a core-shell structure according to the present invention, and a degree of irregularity of a surface thereof.

### DETAILED DESCRIPTION OF THE INVENTION

Unless specifically defined, all technical and scientific terms used herein have the same meaning as commonly understood by a skilled artisan in the relevant technological field.

The materials, processes and examples described herein are for illustrative purposes only and are therefore not intended to be limiting, unless otherwise specified.

All patent applications, patent application publications, patents, scientific and technological literature, publications and references specifically mentioned herein are hereby incorporated by reference in their entirety. In case of conflict, the present specification, including definitions set forth herein, are controlling.

Where a closed or open-ended numerical range is described herein, all values and subranges within or encompassed by the numerical range are to be considered as being specifically included in and belonging to the original disclosure of the present application as if these values and subranges had been explicitly written out in their entirety.

The present invention provides an inkjet recording ink comprising: a resin nanoparticle having a core-shell structure comprising a core and a shell; a pigment; a water-soluble organic solvent; and water, wherein the core comprises a poly(meth)acrylate resin, and wherein the shell comprises a polycarbonate-polyurethane copolymer.

The inventors have conducted extensive studies and discovered that the inkjet recording ink of the present invention solves the above-identified problems associated with conventional inkjet recording inks. Specifically, the inventors have discovered that the inkjet recording ink of the present invention surprisingly exhibits improved ink storage stability, improved discharge stability and a reduction and/or elimination of undesirable adhesion to an inkjet nozzle of an inkjet recording apparatus, and improved resistance to abrasion and smudging, relative to those inferior properties exhibited by conventional inkjet recording inks. The inkjet recording ink of the present invention also exhibits excellent properties with respect to heat resistance, re-dispersion, non-adhesive, mold-releasing, toughness, solvent resistance and film-forming (fixing) properties.

The resin nanoparticle of the present invention has a core-shell structure comprising a core and a shell. An exemplary aspect of the present invention is a core-shell structure comprising a core and a single shell. An additional exemplary aspect of the present invention is a core-shell structure comprising a core and a plurality of two or more shells. For example, the core-shell structure may comprise a core and n number of shells, wherein n=2, 3, 4, 5, 6, 7 or more. The plurality of shells may have an identical or different composition.

An exemplary aspect of the present invention is a core-shell structure comprising a core and a shell, wherein the surface of the core is completely covered by the shell. An additional exemplary aspect of the present invention is a core-shell structure comprising a core and a shell, wherein the surface of the core is partially covered by the shell. A further exemplary aspect of the present invention is a core-shell structure comprising a core and a shell, wherein 0-100% of the surface of the core is covered by one shell or a plurality of two or more shells. For example, 0%, 5%, 10%, 15%, 20%, 25%, 30%, 35%, 40%, 45%, 50%, 55%, 60%, 65%, 70%, 75%, 80%, 85%, 90%, 95% or 100% of the surface of the core is covered by one shell or a plurality of two or more shells.

An exemplary aspect of the present invention is a core-shell structure comprising a core and a shell, wherein a domain of the core is composed of the shell.

An exemplary aspect of the present invention is a core-shell structure comprising a core and a shell, wherein the core comprising the poly(meth)acrylate resin and the shell comprising the polycarbonate-polyurethane copolymer are phase separated from one another.

A core to shell weight ratio is 8/2 to 2/8, including for example, 7/3 to 3/7, 6/4 to 4/6 and 5/5. A core to shell weight ratio of 6/4 to 7/3 is preferred.

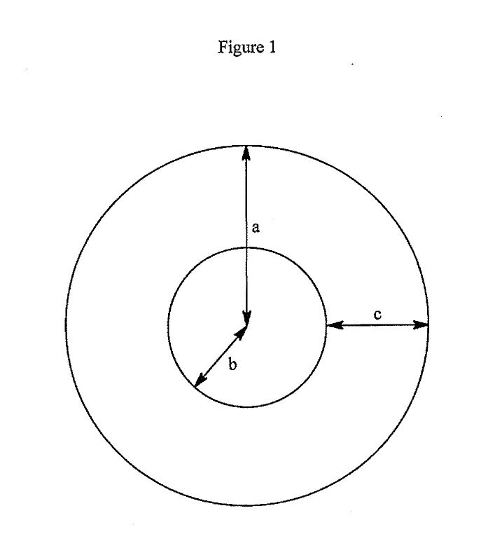

FIG. 1 illustrates a schematic diagram of an exemplary resin nanoparticle having a core-shell structure according to the present invention, and a volume average particle diameter thereof. The resin nanoparticle has a volume average particle diameter represented by “a” in FIG. 1. The core has a volume average particle diameter represented by “b” in FIG. 1. The shell has a volume average particle diameter represented by “c” in FIG. 1.

The resin nanoparticle has a volume average particle diameter (represented by “a” in FIG. 1) of 10-350 nm, including for example, 15-345 nm, 20-340 nm, 25-335 nm, 30-330 nm, 35-325 nm, 40-320 nm, 45-315 nm, 50-310 nm, 55-305 nm, 60-300 nm, 65-295 nm, 70-290 nm, 75-285 nm, 80-280 nm, 85-275 nm, 90-270 nm, 95-265 nm, 100-260 nm, 105-255 nm, 110-250 nm, 115-245 nm, 120-240 nm, 125-235 nm, 130-230 nm, 135-225 nm, 140-220 nm, 145-215 nm, 150-210 nm, 155-205 nm, 160-200 nm, 165-195 nm, 170-190 nm, 175-185 nm, and 180 nm. A volume average particle diameter of 10-300 nm is preferred. A volume average particle diameter of 40-200 nm is particularly preferred.

When the resin nanoparticle has a volume average particle diameter of 10 nm or more, difficulty associated with adjusting the viscosity of the ink in order to ensure that the ink can be efficiently ejected by an inkjet nozzle of an inkjet recording apparatus without clogging can be avoided and/or prevented. When the resin nanoparticle has a volume average particle diameter of 350 nm or less, ink ejection failure caused by clogging of the inkjet nozzle with the resin nanoparticle can be avoided and/or prevented.

The core of the resin nanoparticle has a volume average particle diameter (represented by “b” in FIG. 1) of 5-200 nm, including for example, 10-195 nm, 15-190 nm, 20-185 nm, 25-180 nm, 30-175 nm, 35-170 nm, 40-165 nm, 45-160 nm, 50-155 nm, 55-150 nm, 60-145 nm, 65-140 nm, 70-135 nm, 75-130 nm, 80-125 nm, 85-120 nm, 90-115 nm, 95-110 nm, and 100-105 nm.

The shell of the resin nanoparticle has a volume average particle diameter (represented by “c” in FIG. 1) of 5-150 nm, including for example, 10-145 nm, 15-140 nm, 20-135 nm, 25-130 nm, 30-125 nm, 35-120 nm, 40-115 nm, 45-105 nm, 50-100 nm, 55-95 nm, 60-90 nm, 65-85 nm, 70-80 nm, and 75 nm. When the core is partially or completely covered by a plurality of two or more shells, the volume average particle diameter of 5-150 nm represents the total volume average particle diameter of all of the shells combined.

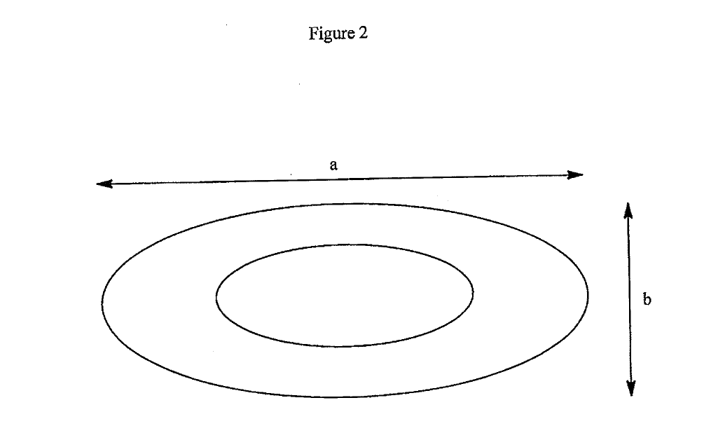

FIG. 2 illustrates a schematic diagram of an exemplary resin nanoparticle having a core-shell structure according to the present invention, and a shape thereof. The shape factor SF-A represents a shape of the resin nanoparticle (e.g., a sphere or an ellipse) and has a value according to the following equation:

SF-A=b/a

where “b” represents the absolute maximum width of the resin nanoparticle, and “a” represents the absolute maximum length of the resin nanoparticle. When the resin nanoparticle has a spherical shape, the shape factor SF-A has a value of 1.0. As the shape factor SF-A value decreases from 1.0, the shape of the resin nanoparticle changes from a spherical shape to an elliptical shape. The shape factor SF-A of the resin nanoparticle is 0.80-1.00, including for example 0.82-0.98, 0.84-0.96, 0.86-0.94, 0.88-0.92, and 0.90. The shape factor SF-A of the resin nanoparticle is preferably 0.88-0.90, and more preferably 0.89.

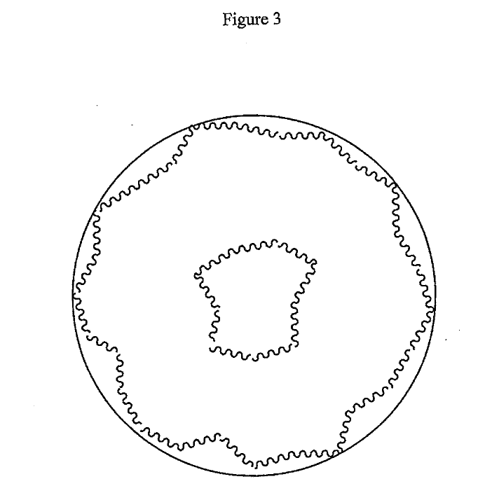

FIG. 3 illustrates a schematic diagram of an exemplary resin nanoparticle having a core-shell structure according to the present invention, and a degree of irregularity of a surface thereof. The shape factor SF-B represents a degree of irregularity of a shape of the resin nanoparticle and has a value according to the following equation:

SF-B=(P2/A)(1/4π)(100)

where “P” represents a maximum perimeter length of the resin nanoparticle, and “A” represents a projected area of the resin nanoparticle. When the resin nanoparticle has a spherical shape, “P” and “A” each have a value of 100. As a value of “P” and “A” increase from 100, the shape of the resin nanoparticle changes from a spherical shape to an indeterminate shape. The shape factor SF-B of the resin nanoparticle is 100-150, including for example 105-145, 110-140, 115-135, 120-130 and 125. The shape factor SF-B of the resin nanoparticle is preferably 100-140.

The core, which comprises the poly(meth)acrylate resin, of the resin nanoparticle has a glass transition temperature (T_{g}) of 0-150° C., including for example 5-145° C., 10-140° C., 15-135° C., 20-130° C., 25-125° C., 30-120° C., 35-115° C., 40-110° C., 45-105° C., 50-100° C., 55-95° C., 60-90° C., 65-85° C., 70-80° C., and 75° C. The shell, which comprises the polycarbonate-polyurethane copolymer, of the resin nanoparticle has a glass transition temperature (T_{g}) of 20-100° C., including for example 25-95° C., 30-90° C., 35-85° C., 40-80° C., 45-75° C., 50-70° C., 55-65° C., and 60° C. When the glass transition temperature (T_{g}) of the core and/or the shell is lower than 0° C. and/or 20° C., respectively, a reduction in ink storage stability may result. When the glass transition temperature (T_{g}) of the core and/or the shell is higher than 150° C. and/or 100° C., respectively, a reduction in resistance to abrasion and/or smudging may result.

The present invention provides an inkjet recording ink comprising: 0.5-5.0 wt. % of a resin nanoparticle, based on a total weight of the inkjet recording ink; and 0.1-50.0 wt. % of a pigment, based on a total weight of the inkjet recording ink.

The inkjet recording ink of the present invention has a solid content of 0.6-55.0 wt. %, based on a total solid content of the resin nanoparticle and the pigment. For example, the total solid content of the resin nanoparticle and the pigment in the inkjet recording ink may be 1.0-55.0 wt. %, 5.0-50.0 wt. %, 10.0-45.0, 15.0-40.0, 20.0-35.0, and 25.0-30.0. A total solid content of the resin nanoparticle and the pigment in the inkjet recording ink is preferably 10.0-40.0 wt. %, more preferably 15.0-35.0 wt. %, and particularly preferably 20.0-30.0 wt. %.

When the total solid content of the resin nanoparticle and the pigment in the inkjet recording ink is more than 40.0 wt. % (e.g., more than 45.0 wt. %, 50.0 wt. % and especially 55.0 wt. %), the viscosity of the ink may become too high and/or the formation of an aggregate of the resin nanoparticle and/or the pigment may occur, which may prevent the ink from being efficiently ejected by the inkjet nozzle, cause clogging of the inkjet nozzle, result in inferior ink storage stability, inferior resistance to abrasion and/or inferior resistance to smudging.

When the total solid content of the resin nanoparticle and the pigment in the inkjet recording ink is less than 10.0 wt. % (e.g., less than 5.0 wt. %, 1.0 wt. % and especially 0.6 wt. %), the viscosity of the ink may become too low, the concentration/number of various additives that may be incorporated into the inkjet recording ink during manufacturing may become limited, and/or inferior ink storage stability may result.

The viscosity of the inkjet recording ink at 25° C. is 30 mPa·s or less, including for example 1-29 mPa·s, 2-28 mPa·s, 3-27 mPa·s, 4-26 mPa·s, 5-25 mPa·s, 6-24 mPa·s, 7-23 mPa·s, 8-22 mPa·s, 9-21 mPa·s, 10-20 mPa·s, 11-19 mPa·s, 12-18 mPa·s, 13-17 mPa·s, 14-16 mPa·s, and 15 mPa·s. The viscosity of the inkjet recording ink at 25° C. is preferably 1-30 mPa·s, more preferably 4-25 mPa·s, and particularly preferably 4-20 mPa·s. If the viscosity of the inkjet recording ink is too high, the inkjet recording ink may not be efficiently ejected by an inkjet nozzle of an inkjet recording apparatus and/or the inkjet recording ink may cause clogging of the inkjet nozzle of the inkjet recording apparatus.

The present invention provides an inkjet recording ink comprising 0.5-5.0 wt. % of a resin nanoparticle, based on a total weight of the inkjet recording ink. For example, the resin nanoparticle may be present in an amount of 0.5-5.0 wt. %, 1.0-4.5 wt. %, 1.5-4.0 wt. %, 2.0-3.5 wt. %, or 2.5-3.0 wt. %, based on a total weight of the inkjet recording ink. When the amount of the resin nanoparticle is less than 0.5 wt. %, resistance to abrasion and/or smudging is insufficient. When the amount of the resin nanoparticle is more than 5.0 wt. %, storage stability and/or discharge stability is insufficient.

The present invention provides an inkjet recording ink comprising: 0.5-5.0 wt. % of a resin nanoparticle, based on a total weight of the inkjet recording ink; a pigment; a water-soluble organic solvent; and water, wherein the resin nanoparticle has a volume average particle diameter of 10-300 nm and a core-shell structure comprising a core and a shell, wherein the core comprises a poly(meth)acrylate resin, and wherein the shell comprises a polycarbonate-polyurethane copolymer.

The weight ratio of poly(meth)acrylate resin to polyurethane-polycarbonate copolymer is 8/2 to 2/8, including for example, 7/3 to 3/7, 6/4 to 4/6 and 5/5. The weight ratio of poly(meth)acrylate resin to polyurethane-polycarbonate copolymer is preferably 6/4 to 7/3.

The present invention also provides a process for producing the inkjet recording ink comprising dispersing a resin nanoparticle and a pigment in water and a water-soluble organic solvent, wherein the resin nanoparticle has a core-shell structure comprising a core and a shell, wherein the core comprises a poly(meth)acrylate resin, and wherein the shell comprises a polycarbonate-polyurethane copolymer.

The present invention also provides a process for producing the inkjet recording ink comprising mixing, in the presence of a water-soluble organic solvent, a pigment dispersion and a resin emulsion, wherein the pigment dispersion comprises a pigment and water, wherein the resin emulsion comprises a resin nanoparticle, wherein the resin nanoparticle has a core-shell structure comprising a core and a shell, wherein the core comprises a poly(meth)acrylate resin, and wherein the shell comprises a polycarbonate-polyurethane copolymer. The resin emulsion may further comprise water, a water-soluble organic solvent, and/or a surfactant. The pigment dispersion may further comprise a water-soluble organic solvent and/or a surfactant.

The resin emulsion may be in the form of an emulsion, a dispersion or a suspension. The resin emulsion may further comprise water, a water-soluble organic solvent, a surfactant, a chain extender, a polymerization initiator (e.g., a radical initiator), an acid diol, a tertiary amine, and/or an additive.

The resin emulsion comprising the resin nanoparticle can be produced by various polymerization methods including, but not limited to, seed polymerization, multi-stage polymerization and power feed polymerization.

The present invention also provides a process for producing a resin emulsion comprising a resin nanoparticle having a core-shell structure comprising a core and a shell, wherein the core comprises a poly(meth)acrylate resin, and wherein the shell comprises a polycarbonate-polyurethane copolymer, wherein the process comprises:

reacting in a reaction mixture at least one polyol compound and at least one carbonate compound in the presence of a catalyst to produce a polycarbonate which is then reacted with at least one polyisocyanate compound to produce a polycarbonate-polyurethane copolymer;

charging a (meth)acrylic acid monomer to the reaction mixture comprising the polycarbonate-polyurethane copolymer to produce a pre-polymer/monomer mixture;

dispersing the pre-polymer/monomer mixture in an aqueous solution comprising a radical initiator and water to produce an aqueous dispersion; and

heating the aqueous dispersion to thereby produce the resin emulsion comprising the resin nanoparticle having the core-shell structure comprising the core and the shell, wherein the core comprises the poly(meth)acrylate resin, and wherein the shell comprises the polycarbonate-polyurethane copolymer.

The reaction mixture of said reacting step may further comprise an acid diol and/or a vinyl monomer. The aqueous solution of said dispersing step may further comprise a tertiary amine and/or a chain extender.

The present invention also provides a process for producing a resin emulsion comprising a resin nanoparticle having a core-shell structure comprising a core and a shell, wherein the core comprises a poly(meth)acrylate resin, and wherein the shell comprises a polycarbonate-polyurethane copolymer, wherein the process comprises:

reacting in a reaction mixture at least one polyol compound, at least one carbonate compound and at least one polyisocyanate compound in the presence of a catalyst to produce a polycarbonate-polyurethane copolymer;

charging a (meth)acrylic acid monomer to the reaction mixture comprising the polycarbonate-polyurethane copolymer to produce a pre-polymer/monomer mixture;

dispersing the pre-polymer/monomer mixture in an aqueous solution comprising a radical initiator and water to produce an aqueous dispersion; and

heating the aqueous dispersion to thereby produce the resin emulsion comprising the resin nanoparticle having the core-shell structure comprising the core and the shell, wherein the core comprises the poly(meth)acrylate resin, and wherein the shell comprises the polycarbonate-polyurethane copolymer.

The reaction mixture of said reacting step may further comprise an acid diol and/or a vinyl monomer. The aqueous solution of said dispersing step may further comprise a tertiary amine and/or a chain extender.

The (meth)acrylic acid monomer may be selected from acrylic acid monomers and/or methacrylic acid monomers, non-limiting examples of which include C₁-C₆ acrylic acid monomers and/or C₁-C₆ methacrylic acid monomers. A “poly(meth)acrylate resin” is understood in the context of the present application to represent a substituted or unsubstituted poly(meth)acrylate resin and/or a substituted or unsubstituted polyacrylate resin.

The polyol compound may be a diol compound, non-limiting examples of which include 1,3-propanediol, 2-methyl-1,3-propanediol, 1,4-butanediol, 1,6-propanediol, and diethylene glycol.

The carbonate compound may be an aliphatic, an aromatic and/or a halogenated carbonate compound, non-limiting examples of which include an ethylene carbonate, a diphenyl carbonate and carbon oxychloride (a.k.a., phosgene).

The polyisocyanate compound may be selected from one or more aliphatic, alicyclic, aliphatic aromatic, and aromatic diisocyanate and polyisocyanate compounds, non-limiting examples of which include ethylene diisocyanate, 1,6-hexamethylene diisocyanate, isophorone diisocyanate, 1,4-cyclohexane-diisocyanate, 4,4′-dicyclohexyl methane diisocyanate, 1,4-phenylene diisocyanate, 2,4-toluene diisocyanate, 2,6-toluene diisocyanate, 4,4′-diphenyl methane diisocyanate, 2,4′-diphenyl methane diisocyanate, poly methylene polyphenyl polyisocyanate, and 1,5-naphthylenediisocyanate.

A non-limiting example of the acid diol, which may be present in the reaction mixture of said reacting step, is 2,2-dimethylol propionic acid.

Non-limiting examples of the vinyl monomer, which may be present in the reaction mixture of said reacting step, include butadiene, styrene, vinyl acetate, vinyl butyric acid, chloroethylene, and vinylidene chloride.

Non-limiting examples of the radical initiator, which is present in the aqueous solution of said dispersing step, include 2,2′-azobis(2,4-dimethylpentane nitrile) and 2,2′-azobis(2-methylpropane nitrile).

Non-limiting examples of the tertiary amine, which may be present in the aqueous solution of said dispersing step, include triethylamine and dimethyl ethanolamine.

Non-limiting examples of the chain extender, which may be present in the aqueous solution of said dispersing step, include ethylenediamine, diethylenetriamine, and triethylenetetraamine.

The aqueous solution of said dispersing step may further comprise a tertiary amine and/or a chain extender.

The present invention provides an inkjet recording ink comprising 0.1-50.0 wt. % of a pigment, based on a total weight of the inkjet recording ink. For example, the pigment may be present in an amount of 5.0-45.0 wt. %, 10.0-40.0 wt. %, 15.0-35.0 wt. %, 20.0-30.0 wt. %, or 25.0 wt. %, based on a total weight of the inkjet recording ink. The amount of the pigment present in the inkjet recording ink is preferably 0.1-20.0 wt. %, based on a total weight of the inkjet recording ink.

The pigment has a number average particle diameter of less than 150 nm, including for example, 145 nm, 140 nm, 135 nm, 130 nm, 125 nm, 120 nm, 115 nm, 110 nm, 105 nm, 100 nm, 95 nm, 90 nm, 85 nm, 80 nm, 75 nm, 70 nm, 65 nm, 60 nm, 55 nm, 50 nm, 45 nm, 40 nm, 35 nm, 30 nm, 25 nm, 20 nm, 15 nm, 10 nm, and 5 nm. A number average particle diameter of less than 100 nm is particularly preferred. The number average particle diameter of the pigment was measured at 23° C. and 55% RH using a Miclo Track UPA dynamic light scattering instrument manufactured by Nikkiso Co., Ltd.

The pigment is not particularly limited and may be selected from one or more inorganic and/or organic pigments.

Non-limiting examples of inorganic pigments include titanium oxide, iron oxide, calcium carbonate, barium sulfate, aluminum hydroxide, barium yellow, cadmium red, chrome yellow, black pigments of metals including for example copper oxide, titanium oxide and iron oxide (e.g., C.I. Pigment Black 11).

Non-limiting examples of organic pigments include azo pigments, azomethine pigments, polycyclic pigments, dye chelates, nitro pigments, nitroso pigments, aniline black and carbon black. Particularly preferred organic pigments include azo pigments, polycyclic pigments, and carbon black.

Non-limiting examples of azo pigments include azo lakes, insoluble azo pigments, condensed azo pigments and chelated azo pigments.

Non-limiting examples of polycyclic pigments include phthalocyanine pigments, perylene pigments, perinone pigments, anthraquinone pigments, quinacridone pigments, dioxadine pigments, indigo pigments, thioindigo pigments, isoindolinone pigments and quinophthalone pigments.

The carbon black includes those produced by customary manufacturing methods (e.g., contact method, furnace method, thermal method and channel method). Carbon black which is produced by a furnace method and a channel method are particularly preferred. Non-limiting examples of carbon black include C.I. Pigment Black 7, furnace black, lamp black, acetylene black, channel black, and aniline black (C.I. Pigment Black 1).

Carbon black having a primary particle size of 15-40 nm, a BET specific surface area of 50-300 m²/g is particularly preferred. Carbon black having a DBP oil absorption of 40 ml/100 g or more, preferably 150 ml/100 g, a volatility of 0.5-10%, and a pH value of 2-9 is particularly preferred.

Non-limiting examples of commercially available carbon black include: No. 2300, No. 900, MCF-88, No. 33, No. 40, No. 45, No. 52, MA7, MA8, MA100, and No. 2200B, which are produced by Mitsubishi Chemical; Raven 700, 5750, 5250, 5000, 3500, and 1255, which are produced by Colombia; Regal 1400R, 330R, 660R, Mogul L, Monarch 700, 800, 880, 900, 1000, 1100, 1300, and 1400, which are produced by Cabot Corp; and Color Black FW1, FW2, FW2V, FW18, FW200, S150, S160, S170, Printex 35, U, V, 140 U, 140V, Special Black 6, 5, 4A and 4, which are produced by Degussa Evonik.

Non-limiting examples of yellow pigments include C.I. Pigment Yellow 1, 2, 3, 12, 13, 14, 16, 17, 73, 74, 75, 83, 93, 95, 97, 98, 114, 120, 128, 129, 138, 150, 151, 154, 155, 174, 180.

Non-limiting examples of magenta pigments include C.I. Pigment Red 5, C.I. Pigment Red 7, 12, 48(Ca), 48(Mn), 57(Ca), 57:1, 112, 122, 123, 146, 168, 176, 184, 185, 202, C.I. Pigment Violet 19.

Non-limiting examples of cyan pigments include C.I. Pigment Blue 1, 2, 3, 15, 15:3, 15:4, 15:34, 16, 22, 60, 63, 66, C.I. Vat Blue 4, C.I. Vat Blue 60.

The specific combination of Pigment Yellow 74 as a yellow pigment, Pigment Red 122 and Pigment Violet 19 as a magenta pigment, and Pigment Blue 15:3 as a cyan pigment, represents a particularly preferred combination of yellow, magenta and cyan pigments for obtaining a inkjet recording ink having an excellent properties, including color tone and light resistance.

The inkjet recording ink and/or the pigment dispersion may further comprise a dye. Preferably, the inkjet recording ink and/or the pigment dispersion do not contain a dye.

Non-limiting examples of the pigment dispersion include a “self dispersing pigment dispersion” and a “surfactant dispersing pigment dispersion.”

A “self dispersing pigment dispersion” is understood to mean in the context of the present application a pigment dispersion comprising a pigment and water, wherein the pigment is dispersible and/or solvable in water without the aid of a surfactant dispersant. The pigment dispersion may further comprise a water-soluble organic solvent and/or an additive.

An exemplary pigment which is dispersible and/or solvable in water without the aid of a surfactant dispersant includes a pigment having a functional group located on a surface thereof as a result of being subjected to a surface treatment, wherein the functional group is selected from the group consisting of a carboxyl group, a carbonyl group, a hydroxyl group, a sulfonic acid group, a phosphate group, a quaternary ammonium, and salts thereof. Non-limiting examples of the surface treatment include a physical surface treatment (e.g., exposure to vacuum plasma) and a chemical surface treatment (e.g., oxidation by exposure to hypochlorite).

A “surfactant dispersing pigment dispersion” is understood to mean in the context of the present application a pigment dispersion comprising a pigment, a surfactant dispersant and water, wherein the pigment is dispersible and/or solvable in water with the aid of a surfactant dispersant. The pigment dispersion may further comprise a water-soluble organic solvent and/or an additive.

Non-limiting examples of the surfactant dispersant include anionic surfactants, cationic surfactants, non-ionic surfactants, and amphoteric surfactants.

The surfactant dispersant preferably includes an anionic surfactant, non-limiting examples of which include polyoxyethylene alkyl ether acetic acid, alkyl benzene sulfonic acid, alkyl diphenyl ether disulfonic acid, dialkyl succinate sulfonic acid, naphthalene sulfonic acid Formalin condensate, polyoxyethylene phenyl ether sulfuric acid, polyoxyethylene alkyl ether sulfuric acid, lauryl acid, oleic acid, dioctyl sulfo succinic acid, polyoxyethylene styrene phenyl ether sulfonic acid, and salts (e.g., NH₄, Na and/or Ca) thereof.

The surfactant dispersant preferably includes an anionic surfactant having a Hydrophilic Lipophilic Balance (HLB) value of 10-20, non-limiting examples of which include polyoxyethylene alkyl ether, polyoxyalkylene alkyl ether, polyoxyethylene polycyclic phenyl ether, sorbitan fatty acid ether, polyoxyethylene sorbitan fatty acid ether, polyoxyethylene alkyl phenyl ether, polyoxyethylene alkylamine, polyoxyethylene alkyl amide, and acetylene glycol. Particularly preferred anionic surfactants having a HLB value of 10-20 include, but are not limited to, polyoxyethylene lauric ether, polyoxyethylene-β-naphthyl ether, polyoxyethylene sorbitan monolaurate, polyoxyethylene sorbitan monooleate, and polyoxyethylene styrene phenyl ether.

The surfactant dispersing pigment dispersion comprises 1.0-100 wt. % of the surfactant dispersant, based on a total weight of the pigment. For example, the surfactant dispersant may be present in an amount of 5.0-95.0 wt. %, 10.0-90.0 wt. %, 15.0-85.0 wt. %, 20.0-80.0 wt. %, 25.0-75.0 wt. %, 30.0-70.0 wt. %, 35.0-65.0 wt. %, 40.0-60.0 wt. %, 45.0-55.0 wt. %, or 50.0 wt. %, based on a total weight of the pigment. The amount of the surfactant dispersant present in the surfactant dispersing pigment dispersion is preferably 5.0-50.0 wt. %, and more preferably 10.0-40.0 wt. %, based on a total weight of the pigment. When the amount of the surfactant dispersant is too low, the pigment is not sufficiently dispersible and/or solvable in water. When the amount of the surfactant dispersant is too high, undesirable properties may result with respect to image bleeding, unacceptably high viscosity, insufficient water resistance, and insufficient abrasion resistance.

As previously discussed, the inkjet recording ink of the present invention comprises a resin nanoparticle having a core-shell structure, a pigment, a water-soluble organic solvent and water. The resin emulsion and/or the pigment dispersion may further comprise a water-soluble organic solvent. If a water-soluble organic solvent is present in both the resin emulsion and the pigment dispersion, the water-soluble organic solvent may be the same or different.

The inkjet recording ink comprises 10.0-50.0 wt. % of the water-soluble organic solvent, based on a total weight of the inkjet recording ink. For example, the water-soluble organic solvent may be present in an amount of 15.0-45.0 wt. %, 20.0-40.0 wt. %, 25.0-35.0 wt. %, or 30.0 wt. %. When the amount of the water-soluble organic solvent is less than 10.0 wt. %, based on a total weight of the inkjet recording ink, the viscosity of the inkjet recording ink is too high and clogging of the inkjet nozzle with the resin nanoparticle and/or the pigment may occur as a result of the resin nanoparticle and/or the pigment not being sufficiently dispersible and/or solvable in water. When the amount of the water-soluble organic solvent is more than 50.0 wt. %, based on a total weight of the inkjet recording ink, an inkjet recorded image having an undesirably reduced image density may result.

The water-soluble organic solvent is understood in the context of the present application to mean one or more organic solvents that are soluble and/or miscible in water. Non-limiting examples of the water-soluble organic solvent include polyhydric alcohols, polyhydric alcohol alkyl ethers, polyhydric alcohol aryl ethers, nitrogen-containing heterocyclic compounds, amides, amines, sulfur-containing compounds, and/or carbonates.

Non-limiting examples of polyhydric alcohols include ethylene glycol, diethylene glycol, 1,3-butanediol, 3-methyl-1,3-butanediol, triethylene glycol, polyethylene glycol, polypropylene glycol, 1,5-pentanediol, 1,6-hexanediol, glycerin, 1,2,6-hexanetriol, 2-ethyl-1,3-hexanediol, ethyl-1,2,4-butanetriol, and 1,2,3-butanetriol.

Non-limiting examples of polyhydric alcohol alkyl ethers include ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Non-limiting examples of polyhydric alcohol aryl ethers include ethylene glycol monophenyl ether, and ethylene glycol monobenzyl ether.

Non-limiting examples of nitrogen-containing heterocyclic compounds include 2-pyrrolidone, N-methyl-2-pyrrolidone, N-hydroxyethyl-2-pyrrolidone, 1,3-dimethylimidazolidinone, ε-caprolactum, and γ-butyrolactone.

Non-limiting examples of amides include formamide, N-methyl formamide, and N,N-dimethyl formamide.

Non-limiting examples of amines include monoethanol amine, diethanol amine, and triethyl amine.

Non-limiting examples of sulfur-containing compounds include dimethyl sulfoxide, sulfolane, and thiodiethanol.

Non-limiting examples of carbonates include propylene carbonate and ethylene carbonate.

The above-mentioned water-soluble organic solvents may be used alone or in combination with one another.

Particularly preferred water-soluble organic solvents include, but are not limited to, glycerin, diethylene glycol, 1,3-butanediol, and 3-methyl-1,3-butanediol because of their ability to reduce and/or prevent discharge failure of the inkjet recording ink from the inkjet nozzle due to issues pertaining to solvent and/or moisture evaporation from the inkjet recording ink, and/or solubility of the resin nanoparticulate and/or pigment in the inkjet recording ink. Moreover, use of these water-soluble solvents provide an inkjet recording ink having excellent storage stability and discharge stability properties.

The present invention also provides a process for producing the inkjet recording ink comprising mixing, in the presence of a water-soluble solvent, a pigment dispersion and a resin emulsion to produce a mixture, wherein the pigment dispersion comprises a pigment and water, wherein the resin emulsion comprises a resin nanoparticle, wherein the resin nanoparticle has a core-shell structure comprising a core and a shell, wherein the core comprises a poly(meth)acrylate resin, and wherein the shell comprises a polycarbonate-polyurethane copolymer. The process may further comprise filtering the mixture, which may be for purification and/or particle size selection purposes, wherein said filtering may include high pressure filtration, reduced pressure filtration, or centrifugal filtration using a centrifugal separator.

The inkjet recording ink of the present invention may further comprise various additives including, but not limited to, another resin emulsion, another pigment dispersion, a penetrant, a dispersant, a stabilizer, an antifoaming agent, a pH adjuster, an antiseptic/antimicrobial agent, a corrosion inhibitor, an antioxidant, and other additives customarily used in inkjet recording ink compositions.

The present invention also provides an inkjet cartridge comprising the inkjet recording ink, an inkjet recording apparatus comprising the inkjet cartridge, and an inkjet recorded image comprising the inkjet recording ink which is ejected from the inkjet nozzle of the inkjet recording apparatus onto a recording medium.

The inkjet recording ink is ejected from the inkjet nozzle of the inkjet recording apparatus onto a recording medium to produce the inkjet recorded image as a result of a recording signal. Inkjet printing systems include continuous ejection printing systems and on-demand printing systems using an inkjet printer and the inkjet recording ink of the present invention. Non-limiting examples of the on-demand printing systems include piezo printing systems, thermal printing systems, and electrostatic printing systems.

JP 2000-198958 describes an inkjet cartridge, an inkjet recording apparatus, and a method of forming an inkjet recorded image. The inkjet recording ink of the present invention can be used in the inkjet cartridge, inkjet recording apparatus and corresponding method described JP 2000-198958. The content of JP 2000-198958 is hereby incorporated by reference in its entirety.

Suitable recording mediums include a material that has an affinity for absorbing the inkjet recording ink of the present invention. A suitable recording medium may also include a material that does not have an affinity for absorbing the inkjet recording ink of the present invention.

Non-limiting examples of suitable recording mediums include paper, a paper-based product, a paper or paper-based product having a water-repellant finish on a surface thereof, a ceramic material, a plastic sheet, a plastic sheet composed of polyethylene terephthalate, polycarbonate, polypropylene, polyethylene, polysulphone, ABS resin, and/or polyvinyl chloride, a substrate having a metal or a non-metal coating deposited on a surface thereof by a deposition technique (e.g., vapor deposition), wherein non-limiting examples of the metal include brass, iron, aluminum, stainless steel, and copper. A particularly preferred recording medium is paper and paper-based products.

The minimum film-forming (fixing) temperature of the resin nanoparticle to the recording medium is 20° C. or lower. When the minimum film-forming (fixing) temperature is higher than 20° C., sufficient fixing of the resin nanoparticle to the recording medium may not occur.

The inventors have discovered that the inkjet recording ink of the present invention exhibits improved ink storage stability, improved discharge stability, reduction and/or elimination of undesirable adhesion to an inkjet nozzle of an inkjet recording apparatus, and improved resistance to abrasion and smudging, relative to those properties exhibited by conventional inkjet recording inks.

While wishing not to be bound by any particular theory, the inventors believe that the resin nanoparticle having a core-shell structure comprising the specific combination of a poly(meth)acrylate resin core and a polycarbonate-polyurethane copolymer shell imparts superior properties to the inkjet recording ink composition of the present invention, which may, in part, be attributable to the excellent heat resistance, re-dispersion, non-adhesive, mold-releasing, toughness, solvent resistance and film-forming (fixing) properties exhibited by the polycarbonate-polyurethane copolymer shell in combination with the poly(meth)acrylate resin core.

The above description is provided to thereby enable a skilled artisan to practice the entire scope of the invention described and claimed herein. Various modifications to the exemplary aspects will be readily apparent to those skilled in the art, and general principles and features defined herein may be applied to other non-exemplified aspects without departing from the spirit and scope of the present invention. Thus, the present invention is not intended to be limited to the aspects exemplified herein, but is to be accorded the broadest reasonable scope consistent with the general principles and features disclosed herein.

Having generally described the present invention, a further understanding can be obtained by reference to the following specific examples, which are provided herein merely for illustration purposes only, and are not intended to be limiting unless otherwise specified.

### EXAMPLES

All percentages listed herein are wt. %, unless otherwise specified.

Preparation of Pigment Dispersion

(1) Black Pigment Dispersion A

90 g of carbon black, having a CTAB specific surface area of 150 m²/g and a DBP oil absorption of 100 mL/100 g, was added to 3,000 mL of a 2.5 N sodium sulfate solution, then oxidized by stirring at 300 rpm at a temperature of 60° C. for 10 hours. The reaction mixture was filtered and the filtered carbon black was neutralized with a sodium hydroxide solution followed by ultra-filtration. The obtained carbon black was rinsed with water, dried and dispersed in purified water to obtain a 20 wt. % pigment concentration of a surface-treated carbon black pigment dispersion A.

(2) Cyan Pigment Dispersion A

A cyan pigment dispersion was prepared where C.I. Pigment Blue 15:3 was plasma-treated at low temperature and a carboxyl group was introduced. A liquid having the cyan pigment dispersed in deionized water was de-mineralized and concentrated with an ultra-filter, and a cyan pigment dispersion having a 15 wt. % concentration was obtained.

(3) Magenta Pigment Dispersion A

A magenta pigment dispersion where a carboxyl group was introduced was prepared in a manner similar to the preparation of the cyan pigment dispersion A discussed in (2) above with the exception that C.I. Pigment Blue 15:3 was replaced with C.I. Pigment Red 122.

(4) Yellow Pigment Dispersion A

A yellow pigment dispersion where a carboxyl group was introduced was prepared in a manner similar to the preparation of the cyan pigment dispersion A discussed in (2) above with the exception that C.I. Pigment Blue 15:3 was replaced with C.I. Pigment Yellow 74.

(5) Black Pigment Dispersion B

Carbon Black (NIPEX150-IQ Gas Black, manufactured by DEGUSSA): 20 wt. %

Naphthalene sulfonate acid-formalin condensate (PIONIN A-45-PN, manufactured by Takemoto Oil & Fat Co., Ltd.): 5 wt %

Distilled Water: balance

The above-mentioned components were pre-mixed and then circular dispersed using a disc type bead mill (manufactured by Shinmaru Enterprises Corp., KDL) equipped with zirconia ball media having a diameter of 0.3 mm, to obtain the black pigment dispersion.

(6) Cyan Pigment Dispersion B

A cyan pigment dispersion was prepared in a manner similar to the preparation of the black pigment dispersion B discussed in (5) above with the exception that Carbon Black was replaced with C.I. Pigment Blue 15:3.

(7) Magenta Pigment Dispersion B

A magenta pigment dispersion was prepared in a manner similar to the preparation of the black pigment dispersion B discussed in (5) above with the exception that Carbon Black was replaced with C.I. Pigment Red 122.

(8) Yellow Pigment Dispersion B

A yellow pigment dispersion was prepared in a manner similar to the preparation of the black pigment dispersion B discussed in (5) above with the exception that Carbon Black was replaced with C.I. Pigment Yellow 74.

### Synthesis of Resin Emulsion

### Synthesis Example 1

The following raw materials were placed in a 2 L separable flask equipped with an agitator, a thermometer, and an Oldershaw type rectifying column (having a vacuum jacket attached to the reflux head), then 0.015 g of lead(II) acetate trihydrate was charged into the separable flask as a catalyst, then the reaction mixture was stirred at 70° C.:

1. 1050 g of 2-methyl-1,3-propanediol,

2. 1030 g of ethylenecarbonate,

Then the reaction mixture was reacted for a period of 12 hrs at a temperature of 140° C. (inside of flask) and under a pressure of 1.0-1.5 kPa. The flask was heated using an oil bath with a temperature setting of 175° C. During the reaction, a part of the flux was vacuumed from the reflux head at a reflect ratio of 4.

Then, the Oldershaw type rectifying column was changed to a single distillation column, and the reaction mixture was reacted at a temperature of 140-150° C. (inside of flask) under a pressure of 0.5 kPa. The flask was heated using an oil bath with a temperature setting of 180° C.

Then, the reaction mixture was reacted at 160-165° C. for a period of 4.0 hrs while removing a generated diol (inside of flask). The flask was heated using an oil bath with a temperature setting of 185° C.

Then a polycarbonate was obtained.

The following raw materials were placed in a reaction vessel, equipped with a nitrogen gas capillary, and reacted with stirring at a temperature of 94° C. for a period of 0.5 hr: (1) the polycarbonate obtained above in an amount of 100 parts by mass; (2) 3-isocyanatomethyl-3,5,5-trimethylcyclohexyl isocyanate (a.k.a., isophorone diisocyanate) in an amount of 55 parts by mass; and (3) 10% dibutyltin dilaurate (DABCOT-12, manufactured by Air Products and Chemicals) in an amount of 0.2 parts by mass.

Then 25 parts by mass of N-methyl-2-pyrrolidone (NMP) was added and the presence or absence of unreacted NCO groups was confirmed.

Then 14 parts by mass of dimethylol propionic acid and 27 parts by mass of N-methyl-2-pyrrolidone (NMP) were added, then the reaction mixture was maintained at a temperature of 94° C. for a period of 2.5 hr.

Then the temperature of the reaction mixture was reduced to 25° C. while butylacrylate (149 parts by mass), styrene (65 parts by mass) and hexanediolacryrate (0.9 parts by mass) were added to obtain a melt.

The melt was then diluted with water (502 parts by mass) and kept at a temperature of 25° C. to obtain a pre-polymer solution.

The pre-polymer solution was slowly added to another container and then 2,2′-azobis(2-methylpropanenitrile) (VAZO64, manufacture by DuPont) (0.9 parts by mass), N-methyl-2-pyrrolidone (NMP) (8.4 parts by mass) and a solution of ethylenediamine (10 parts by mass) diluted with water (20 parts by mass) were added to the container and heated to a temperature setting of 65° C., wherein the temperature of the reaction mixture reached a temperature of 65-75° C. due to the exothermic reaction, while maintaining a monomer concentration of less than 1,000 ppm, to obtain a resin emulsion A, which comprises a resin nanoparticle having a core-shell structure comprising a core and a shell, wherein the core comprises a poly(meth)acrylate resin, and wherein the shell comprises a polycarbonate-polyurethane copolymer.

### Synthesis Example 2

A resin emulsion B was prepared in the same manner as described in Synthesis Example 1 with the exception that 3-isocyanatomethyl-3,5,5-trimethylcyclohexyl isocyanate (a.k.a., isophorone diisocyanate) was replaced with an equivalent amount of 4,4′-dicyclohexylmethane diisocyanate, and butylacrylate and styrene were replaced with an equivalent amount of methyl methacrylate, to obtain the resin emulsion B, which comprises a resin nanoparticle having a core-shell structure comprising a core and a shell, wherein the core comprises a poly(meth)acrylate resin, and wherein the shell comprises a polycarbonate-polyurethane copolymer.

### Synthesis Example 3

A resin emulsion C was prepared in the same manner as described in Synthesis Example 1 with the exception that the polycarbonate was replaced with an equivalent amount of a polyester polyol, namely poly(neopentyl glycol adipate) (Fomrez 55-56 manufactured by Witco Chemical), to obtain the resin emulsion C, which comprises a resin nanoparticle having a core-shell structure comprising a core and a shell, wherein the core comprises a polyacrylate resin, and wherein the shell comprises a polyester-polyurethane resin.

### Examples 1-10 and Comparative Examples 1-16

### Preparation of Ink

The respective components in the Tables were mixed for 1.5 hours and the resultant mixtures were filtered using a membrane filter having a pore size of 0.8 mm to thereby prepare the respective ink.

The following materials listed in the Tables are present in terms of weight %:

Organic solvent A: glycerin

Organic solvent B: 1.3-butanediol

Organic solvent C: 2,2,4-trimethyl-1,3-pentanediol

Resin emulsion A: inventive resin emulsion of Synthesis Example 1

Resin emulsion B: inventive resin emulsion of Synthesis Example 2

Resin emulsion C: conventional acrylic resin emulsion (Boncoat R-3380-E, manufactured by DIC Corp.)

Resin emulsion D: conventional urethane resin emulsion (Super Frex 460, manufactured by Daiichi Kogyo Seiyaku Co., Ltd.)

Resin emulsion E: conventional resin emulsion of Synthesis Example 3

Resin emulsion F: conventional polyester resin emulsion (Pesresin A210, manufactured by Takamatsu Co., Ltd.)

Resin emulsion G: conventional polyolefin resin emulsion (Chemipearl S-100, manufactured by Mitsui Petroleum Chemical Co., Ltd.)

Ink Storage Stability

The respective ink composition of Examples 1-10 and Comparative Examples 1-16 was filled in a cartridge and stored at 65° C. for 3 weeks. The ink storage stability property was evaluated based on the occurrence or non-occurrence of an increase in viscosity and/or cohesion according to the following criteria.

Evaluation Criteria

©: Very Good Ink Storage Stability: Viscosity increase and cohesion not observed

◯: Good Ink Storage Stability: Viscosity increase and/or cohesion barely observed.

Δ: Bad Ink Storage Stability: Viscosity increase and/or cohesion clearly observed.

X: Very Bad Ink Storage Stability: Viscosity increase and cohesion remarkably observed.

The results of this evaluation are shown in the following Tables 1-3.

Adhesion to Nozzle

An inkjet printer (IPSioGX5000, manufactured by NBS Ricoh Co., Ltd.) equipped with a thermohygrostat was used for measuring adhesion of the respective the respective ink composition of Examples 1-10 and Comparative Examples 1-16 to the nozzle of the inkjet printer. The temperature and humidity of the thermohygrostat was set at 32° C. and 30% RH. Continuous printing of a print pattern chart on 20 pieces of a recording medium followed by a 20 minute pause was repeated 50 times. The printing area of each respective color is 5% based on a total area of the paper surface. The printing density was 300 dpi for one pass printing. Following 1,000 pieces of total printing, microscopic observation of the nozzle and an evaluation of ink adhesion to the nozzle was conducted.

Evaluation Criteria

©: Ink adhesion to nozzle not observed.

◯: Ink adhesion to nozzle barely observed.

Δ: Ink adhesion to nozzle clearly observed.

X: Ink adhesion to nozzle remarkably observed.

The results of this evaluation are shown in the following Tables 1-3.

Abrasion Resistance

The above-mentioned inkjet printer (IPSioGX5000) was used for measuring the abrasion resistance of the respective ink composition of Examples 1-10 and Comparative Examples 1-16. Printing was performed on Type 6200 paper (manufactured by NBS Ricoh Co., Ltd.) with a printing density of 600 dpi. After the printed images had dried, the printed images were rubbed ten times with a cotton cloth. The state of transferred pigment from the dried printed image to the cotton cloth after having been rubbed ten times was evaluated by visual observation of the cotton cloth.

Evaluation Criteria

©: Transferred pigment to cotton cloth not observed.

◯: Transferred pigment to cotton cloth barely observed.

Δ: Transferred pigment to cotton cloth clearly observed.

X: Transferred pigment to cotton cloth remarkably observed.

The results of this evaluation are shown in the following Tables 1-3.

Smudging Resistance

The above-mentioned inkjet printer (IPSioGX5000) was used for measuring the smudging resistance of the respective ink composition of Examples 1-10 and Comparative Examples 1-16. Printing was performed on Type 6200 paper (manufactured by NBS Ricoh Co., Ltd.) with a printing density of 600 dpi. After the printed images had dried, the printed images were traced with a fluorescent marker (PROPUS2, manufactured by Mitsubishi Pencil Co., Ltd.). The state of smudging or smearing of the pigment on the dried printed image after having been traced with the fluorescent marker was evaluated by visual observation of the printed image.

Evaluation Criteria

©: Smudging not observed.

◯: Smudging barely observed.

Δ: Smudging clearly observed.

X: Smudging remarkably observed.

The results of this evaluation are shown in the following Tables 1-3.

TABLE 1

| | | | Examples | | | | | | | | | |
|---|---|---|---|---|---|---|---|---|---|---|---|---|
| Composition of ink | | | 1 | 2 | 3 | 4 | 5 | 6 | 7 | 8 | 9 | 10 |
| Pigment | Black Dispersion A | (as solid) | 8.0 | | | | | | | | 8.0 | |
| Dispersion | Cyan Dispersion A | (as solid) | | 6.0 | | | | | | | | |
| | Magenta Dispersion A | (as solid) | | | 6.0 | | | | | | | |
| | Yellow Dispersion A | (as solid) | | | | 6.0 | | | | | | |
| | Black Dispersion B | (as solid) | | | | | 8.0 | | | | | |
| | Cyan Dispersion B | (as solid) | | | | | | 6.0 | | | | 6.0 |
| | Magenta Dispersion B | (as solid) | | | | | | | 6.0 | | | |
| | Yellow Dispersion B | (as solid) | | | | | | | | 6.0 | | |
| Water- | Organic Solvent A | | 15.0 | 10.0 | 10.0 | 10.0 | 15.0 | 10.0 | 10.0 | 10.0 | | |
| Miscible | Organic Solvent B | | 15.0 | 20.0 | 20.0 | 20.0 | | | | | 15.0 | 10.0 |
| Organic | Organic Solvent C | | | | | | 15.0 | 20.0 | 20.0 | 20.0 | 15.0 | 20.0 |
| Solvent | | | | | | | | | | | | |
| Resin | Resin Emulsion A | (as solid) | 3.0 | 3.0 | 3.0 | 3.0 | | | | | 3.0 | |
| Emulsion | Resin Emulsion B | (as solid) | | | | | 3.0 | 3.0 | 3.0 | 3.0 | | 3.0 |
| | Resin Emulsion C | (as solid) | | | | | | | | | 1.0 | |
| | Resin Emulsion D | (as solid) | | | | | | | | | | |
| | Resin Emulsion E | (as solid) | | | | | | | | | | 1.0 |
| | Resin Emulsion F | (as solid) | | | | | | | | | | |
| | Resin Emulsion G | (as solid) | | | | | | | | | | |
| Water | Pured Water | | Remain | Remain | Remain | Remain | Remain | Remain | Remain | Remain | Remain | Remain |
| | Total (%) | | 100.0 | 100.0 | 100.0 | 100.0 | 100.0 | 100.0 | 100.0 | 100.0 | 100.0 | 100.0 |

| | | | | | | | | | | |
|---|---|---|---|---|---|---|---|---|---|---|
| Ink Storage Stability | ⊚ | ⊚ | ⊚ | ⊚ | ⊚ | ⊚ | ⊚ | ⊚ | ⊚ | ⊚ |
| Adhesion to Nozzle | ⊚ | ⊚ | ⊚ | ⊚ | ⊚ | ⊚ | ⊚ | ⊚ | ◯ | ◯ |
| Abrasion Resistance | ⊚ | ⊚ | ⊚ | ⊚ | ⊚ | ⊚ | ⊚ | ⊚ | ⊚ | ⊚ |
| Smudging Resistance | ⊚ | ⊚ | ⊚ | ⊚ | ⊚ | ⊚ | ⊚ | ⊚ | ⊚ | ⊚ |

TABLE 2

| | | | Comparative Examples | | | | | | | | | |
|---|---|---|---|---|---|---|---|---|---|---|---|---|
| Composition of ink | | | 1 | 2 | 3 | 4 | 5 | 6 | 7 | 8 | 9 | 10 |
| Pigment | Black Dispersion A | (as solid) | 8.0 | | | | | | 8.0 | | | |
| Dispersion | Cyan Dispersion A | (as solid) | | | | | | | | 8.0 | | |
| | Magenta Dispersion A | (as solid) | | | 8.0 | | | | | | | |
| | Yellow Dispersion A | (as solid) | | | | 8.0 | | | | | | |
| | Black Dispersion B | (as solid) | | | | | 8.0 | | | | | |
| | Cyan Dispersion B | (as solid) | | 8.0 | | | | 6.0 | | | | |
| | Magenta Dispersion B | (as solid) | | | | | | | | | 6.0 | |
| | Yellow Dispersion B | (as solid) | | | | | | | | | | 6.0 |
| Water- | Organic Solvent A | | 15.0 | 10.0 | 10.0 | 10.0 | 15.0 | 10.0 | 10.0 | 10.0 | 10.0 | 10.0 |
| Miscible | Organic Solvent B | | 15.0 | 20.0 | 20.0 | 20.0 | | | | | 20.0 | 20.0 |
| Organic | Organic Solvent C | | | | | | 15.0 | 20.0 | 20.0 | 20.0 | | |
| Solvent | | | | | | | | | | | | |
| Resin | Resin Emulsion A | (as solid) | | | | | | | | | | |
| Emulsion | Resin Emulsion B | (as solid) | | | | | | | | | | |
| | Resin Emulsion C | (as solid) | 3.0 | 3.0 | | | 1.5 | 1.5 | | | | |
| | Resin Emulsion D | (as solid) | | | 3.0 | 3.0 | 1.5 | 1.5 | | | | |
| | Resin Emulsion E | (as solid) | | | | | | | 3.0 | 3.0 | | |
| | Resin Emulsion F | (as solid) | | | | | | | | | 3.0 | 3.0 |
| | Resin Emulsion G | (as solid) | | | | | | | | | | |
| Water | Pured Water | | Remain | Remain | Remain | Remain | Remain | Remain | Remain | Remain | Remain | Remain |
| | Total (%) | | 100.0 | 100.0 | 100.0 | 100.0 | 100.0 | 100.0 | 100.0 | 100.0 | 100.0 | 100.0 |

| | | | | | | | | | | |
|---|---|---|---|---|---|---|---|---|---|---|
| Ink Storage Stability | Δ | Δ | ⊚ | ⊚ | ◯ | ◯ | X | X | Δ | Δ |
| Adhesion to Nozzle | X | X | Δ | Δ | X | X | Δ | Δ | Δ | Δ |
| Abrasion Resistance | Δ | Δ | X | X | ◯ | ◯ | ◯ | ◯ | Δ | Δ |
| Smudging Resistance | Δ | Δ | Δ | Δ | Δ | Δ | ◯ | ◯ | X | X |

TABLE 3

| | | | Comparative Examples | | | | | |
|---|---|---|---|---|---|---|---|---|
| Composition of ink | | | 11 | 12 | 13 | 14 | 15 | 16 |
| Pigment | Black Dispersion A | (as solid) | | | 8.0 | | | |
| Dispersion | Cyan Dispersion A | (as solid) | | | | 8.0 | | |
| | Magenta Dispersion A | (as solid) | | | | | | |
| | Yellow Dispersion A | (as solid) | | | | | | |
| | Black Dispersion B | (as solid) | 8.0 | | | | | |
| | Cyan Dispersion B | (as solid) | | 8.0 | | | | |
| | Magenta Dispersion B | (as solid) | | | | | 8.0 | |
| | Yellow Dispersion B | (as solid) | | | | | | 8.0 |
| Water- | Organic Solvent A | | | | | | | |
| Miscible | Organic Solvent B | | 15.0 | 15.0 | 15.0 | 10.0 | 15.0 | 10.0 |
| Organic | Organic Solvent C | | 15.0 | 15.0 | 15.0 | 20.0 | 15.0 | 20.0 |
| Solvent | | | | | | | | |
| Resin | Resin Emulsion A | (as solid) | | | | | | |
| Emulsion | Resin Emulsion B | (as solid) | | | | | | |
| | Resin Emulsion C | (as solid) | | | | | | |
| | Resin Emulsion D | (as solid) | | | | | | |
| | Resin Emulsion E | (as solid) | | | | | | |
| | Resin Emulsion F | (as solid) | | | | | | |
| | Resin Emulsion G | (as solid) | 3.0 | 3.0 | | | | |
| Water | Pured Water | | Remain | Remain | Remain | Remain | Remain | Remain |
| | Total (%) | | 100.0 | 100.0 | 100.0 | 100.0 | 100.0 | 100.0 |

| | | | | | | |
|---|---|---|---|---|---|---|
| Ink Storage Stability | X | X | ⊚ | ⊚ | ⊚ | ⊚ |
| Adhesion to Nozzle | X | X | ⊚ | ⊚ | ⊚ | ⊚ |
| Abrasion Resistance | ◯ | ◯ | X | X | X | X |
| Smudging Resistance | ◯ | ◯ | X | X | X | X |

As is clearly evident from the results shown in Tables 1-3 above, the inkjet recording inks of Examples 1-10, which comprise a resin nanoparticle having a core-shell structure comprising a core and a shell, a pigment, a water-soluble organic solvent, and water, wherein the core comprises a poly(meth)acrylate resin, and wherein the shell comprises a polycarbonate-polyurethane copolymer in accordance with the present invention, exhibit improved ink storage stability, improved discharge stability, a reduction and/or elimination of undesirable adhesion to the inkjet nozzle of the inkjet recording apparatus, and improved resistance to abrasion and smudging, relative to those inferior properties exhibited by conventional inkjet recording inks of Comparative Examples 1-16, which do not contain the inventive resin nanoparticle.

The resin emulsions of Examples 1 and 2, which comprise a resin nanoparticle having a core-shell structure comprising a core and a shell, wherein the core comprises a poly(meth)acrylate resin, and wherein the shell comprises a polycarbonate-polyurethane copolymer in accordance with the present invention, exhibited excellent ink storage stability, excellent discharge stability and a reduction and/or elimination of undesirable adhesion to the inkjet nozzle of the inkjet recording apparatus, and excellent resistance to abrasion and smudging.

In contrast, the conventional acrylic resin emulsions of Comparative Examples 1 and 2 exhibited poor ink storage stability, very poor discharge stability and unacceptably high adhesion to the inkjet nozzle of the inkjet recording apparatus, and poor resistance to abrasion and smudging.

In contrast, the conventional urethane resin emulsions of Comparative Examples 3 and 4 exhibited poor discharge stability and undesirable adhesion to the inkjet nozzle of the inkjet recording apparatus, very poor resistance to abrasion, and poor resistance to smudging.

In contrast, the conventional resin emulsions of Comparative Examples 5 and 6, which comprise a mixture of a conventional acrylic resin emulsion and a conventional urethane resin emulsion, exhibited very poor discharge stability and unacceptably high adhesion to the inkjet nozzle of the inkjet recording apparatus, and poor resistance to smudging.

In contrast, the conventional resin emulsion of Comparative Examples 7 and 8, which comprise a resin nanoparticle having a core-shell structure comprising a core and a shell, wherein the core comprises a polyacrylate resin, and wherein the shell comprises a polyester-polyurethane resin in accordance with Synthesis Example 3, exhibited very poor discharge stability, poor discharge stability and undesirable adhesion to the inkjet nozzle of the inkjet recording apparatus.

In contrast, the conventional polyester resin emulsions of Comparative Examples 9 and 10 exhibited poor ink storage stability, poor discharge stability and undesirable adhesion to the inkjet nozzle of the inkjet recording apparatus, poor resistance to abrasion, and very poor resistance to smudging.

In contrast, the conventional polyolefin resin emulsions of Comparative Examples 11 and 12 exhibited very poor ink storage stability, and very poor discharge stability and unacceptably high adhesion to the inkjet nozzle of the inkjet recording apparatus.

In contrast, Comparative Examples 13-16 in which a resin emulsion was not used, exhibited excellent ink storage stability, excellent discharge stability and a reduction and/or elimination of undesirable adhesion to the inkjet nozzle of the inkjet recording apparatus, but very poor resistance to abrasion and smudging.

Numerous modifications and variations on the present invention are obviously possible in light of the above disclosure and thus the present invention may be practiced otherwise than as specifically described herein without departing from sprit and scope of the present invention. Accordingly, it is therefore to be understood that the foregoing disclosure is merely illustrative of exemplary aspects of the present invention and that numerous modifications and variations can be readily made by skilled artisans that fall within the scope of the accompanying claims.

1. An ink composition comprising:
a resin nanoparticle having a core-shell structure comprising a core and a shell;
a pigment;
a water-soluble organic solvent; and
water,
wherein the core comprises a poly(meth)acrylate resin, and
wherein the shell comprises a polycarbonate-polyurethane copolymer.

2. The ink composition according to claim 1, wherein the resin nanoparticle has a volume average particle diameter of 10-350 nm.

3. The ink composition according to claim 1, wherein the core has a volume average particle diameter of 5-200 nm.

4. The ink composition according to claim 1, wherein the shell has a volume average particle diameter of 5-150 nm.

5. The ink composition according to claim 1, wherein the resin nanoparticle has a core to shell weight ratio of 8/2 to 2/8.

6. The ink composition according to claim 1, wherein the resin nanoparticle has a shape factor SF-A value of 0.88-0.90.

7. The ink composition according to claim 1, which comprises:
0.5-5.0 wt. % of the resin nanoparticle, based on a total weight of the ink composition;
0.1-50.0 wt. % of the pigment, based on a total weight of the ink composition; and
10.0-50.0 wt. % of the water-soluble organic solvent, based on a total weight of the ink composition.

8. A process for producing the inkjet composition according to claim 1, wherein the process comprises dispersing the resin nanoparticle and the pigment in water and the water-soluble solvent.

9. A process for producing the inkjet composition according to claim 1, wherein the process comprises mixing, in the presence of the water-soluble solvent, a resin emulsion and a pigment dispersion, wherein the resin emulsion comprises the resin nanoparticle, and wherein the pigment dispersion comprises the pigment and water.

10. The process according to claim 9, wherein the pigment dispersion is a self dispersing pigment dispersion.

11. The process according to claim 9, wherein the pigment dispersion is a surfactant dispersing pigment dispersion.

12. A process for producing the resin emulsion according to claim 9, wherein the process comprises:
reacting in a reaction mixture at least one polyol compound and at least one carbonate compound in the presence of a catalyst to produce a polycarbonate which is then reacted with at least one polyisocyanate compound to produce a polycarbonate-polyurethane copolymer;
charging a (meth)acrylic acid monomer to the reaction mixture comprising the polycarbonate-polyurethane copolymer to produce a pre-polymer/monomer mixture;
dispersing the pre-polymer/monomer mixture in an aqueous solution comprising a radical initiator and water to produce an aqueous dispersion; and
heating the aqueous dispersion to thereby produce the resin emulsion comprising the resin nanoparticle having the core-shell structure comprising the core and the shell, wherein the core comprises the poly(meth)acrylate resin, and wherein the shell comprises the polycarbonate-polyurethane copolymer.

13. The process according to claim 12, wherein:
the (meth)acrylic acid monomer is selected from the group consisting of one or more C₁-C₆ acrylic acid monomers, one or more C₁-C₆ methacrylic acid monomers, and combinations thereof;
the polyol compound is selected from the group consisting of 1,3-propanediol, 2-methyl-1,3-propanediol, 1,4-butanediol, 1,6-propanediol, diethylene glycol, and combinations thereof;
the carbonate compound is selected from the group consisting of ethylene carbonate, diphenyl carbonate, carbon oxychloride, and combinations thereof; and
the polyisocyanate compound is selected from the group consisting of ethylene diisocyanate, 1,6-hexamethylene diisocyanate, isophorone diisocyanate, 1,4-cyclohexane-diisocyanate, 4,4′-dicyclohexyl methane diisocyanate, 1,4-phenylene diisocyanate, 2,4-toluene diisocyanate, 2,6-toluene diisocyanate, 4,4′-diphenyl methane diisocyanate, 2,4′-diphenyl methane diisocyanate, poly methylene polyphenyl polyisocyanate, 1,5-naphthylenediisocyanate, and combinations thereof.

14. A process for producing the resin emulsion according to claim 9, wherein the process comprises:
reacting in a reaction mixture at least one polyol compound, at least one carbonate compound and at least one polyisocyanate compound in the presence of a catalyst to produce a polycarbonate-polyurethane copolymer;
charging a (meth)acrylic acid monomer to the reaction mixture comprising the polycarbonate-polyurethane copolymer to produce a pre-polymer/monomer mixture;
dispersing the pre-polymer/monomer mixture in an aqueous solution comprising a radical initiator and water to produce an aqueous dispersion; and
heating the aqueous dispersion to thereby produce the resin emulsion comprising the resin nanoparticle having the core-shell structure comprising the core and the shell, wherein the core comprises the poly(meth)acrylate resin, and wherein the shell comprises the polycarbonate-polyurethane copolymer.

15. The process according to claim 14, wherein:
the (meth)acrylic acid monomer is selected from the group consisting of one or more C₁-C₆ acrylic acid monomers, one or more C₁-C₆ methacrylic acid monomers, and combinations thereof;
the polyol compound is selected from the group consisting of 1,3-propanediol, 2-methyl-1,3-propanediol, 1,4-butanediol, 1,6-propanediol, diethylene glycol, and combinations thereof;
the carbonate compound is selected from the group consisting of ethylene carbonate, diphenyl carbonate, carbon oxychloride, and combinations thereof; and
the polyisocyanate compound is selected from the group consisting of ethylene diisocyanate, 1,6-hexamethylene diisocyanate, isophorone diisocyanate, 1,4-cyclohexane-diisocyanate, 4,4′-dicyclohexyl methane diisocyanate, 1,4-phenylene diisocyanate, 2,4-toluene diisocyanate, 2,6-toluene diisocyanate, 4,4′-diphenyl methane diisocyanate, 2,4′-diphenyl methane diisocyanate, poly methylene polyphenyl polyisocyanate, 1,5-naphthylenediisocyanate, and combinations thereof.

16. The ink composition according to claim 1, which is an inkjet recording ink.

17. An inkjet cartridge comprising the inkjet recording ink according to claim 16.

18. An inkjet recording apparatus comprising the inkjet cartridge according to claim 17.

19. An inkjet recorded image comprising the inkjet recording ink according to claim 16 located on a recording medium.
